(19) United States
(12) Patent Application Publication
(10) Pub. No.: US 2002/0004788 A1
(43) Pub. Date: Jan. 10, 2002

(54) Commodity trading of bandwidth

(76) Inventors: Thomas D. Gros, Houston, TX (US); David Berberian JR., Houston, TX (US); Stanley P. Hanks, Portland, OR (US)

Correspondence Address: Chris N. Cravey, Vinson & Elkins L.L.P., 2300 First City Tower, 1001 Fannin Street, Houston, TX, 77002-6760, US

(21) Appl. No.: 09/860,682

(22) Filed: May 18, 2001

Related U.S. Application Data
(60) Provisional application No. 60/205,527, filed on May 19, 2000.

(51) Int. Cl. G06F 17/60

(52) U.S. Cl. 705/80; 705/8

(57) ABSTRACT

A method includes pooling bandwidth between first and second pooling points in a communication system. The pooled bandwidth is commoditized by making available tradeable bandwidth segments having negotiable sizes and characteristics. A transaction between a buyer and a seller for at least one bandwidth segment is initiated, wherein the seller delivers to the buyer bandwidth between the first and second pooling points pursuant to agreed upon terms. The delivered bandwidth is monitored to ensure that the bandwidth is delivered according to the agreed upon terms. A system includes a first pooling point, a second pooling point, a service provisioning system, a cross connection switch, and a quality of service manager. The second pooling point is coupled to the first pooling point and bandwidth is pooled between the first and second pooling points. The pooled bandwidth is commoditized by making available tradeable bandwidth segments having a negotiable size and a determinable quality of service. The service provisioning system is coupled to at least on of the first and second pooling points, and the service provisioning system facilitates a transaction between a buyer and a seller for bandwidth at a contracted for quality of service. The cross connection switch is coupled to at least one of the first and second pooling points, and the cross connection switch executes the transaction between the buyer and seller by enabling delivery of bandwidth between the first and second pooling points at the contracted for quality of service. The quality of service manager is coupled to at least one of the first and second pooling points, and the quality of service manager monitors the delivered bandwidth to ensure that the contracted for quality of service is delivered.

This application claims the benefit of U.S. Provisional Application No. 60/205,527 filed May 19, 2000.

### BACKGROUND OF THE INVENTION

1. Field of the Invention

This invention relates generally to trading systems, and, more particularly, to the commodity trading of bandwidth.

2. Description of the Related Art

The Internet has become vital to both businesses and consumers. The initial role of the Internet as an information tool has led to an explosive adoption of its use; however, the massive growth of the Internet has outpaced the capabilities of its infrastructure. Content providers have moved from providing static information to distributing applications that consume large amounts of bandwidth. In addition to data transmissions, the increase in global communications has resulted in a corresponding increase in the demand for voice minutes (i.e., bandwidth utilized for voice transmissions). The ability to send data or voice communications between two geographically distributed points is typically a function of the availability, quality, and capacity of the bandwidth between the two points.

To facilitate data and voice transmissions, telecommunication companies, content providers, end users, and the like, have become increasingly more dependent on the availability of competitively priced globally accessible bandwidth. However, because of the inherent variable characteristics of bandwidth (e.g., capacity, latency, error rate, etc.), it is difficult to comparatively evaluate pricing and other characteristics of available bandwidth. That is, it may be difficult if not impossible for a bandwidth consumer to determine whether the contractual terms that go along with available bandwidth (e.g., price, capacity, quality, duration, etc.) make good business sense. The problem may be exacerbated by the fact that much of the available bandwidth capacity is controlled by a small group of bandwidth providers, thus, placing the bandwidth providers in a much stronger bargaining position than the bandwidth consumers.

One solution to the increasing demand for bandwidth is long-term bandwidth contracts. In one illustrative embodiment, “bandwidth” brokers may function as “match makers” or electronic bulletin boards for long distance voice call minutes and point-to-point long-term bandwidth contracts. For example, a seller of either of these services may post to a web site an “offer” for a level of capacity at a defined price for a specific term (usually anywhere from 12-24 months). A buyer might post a “bid” for the service. These brokers introduce the buyer and seller who then get together and attempt to consummate a transaction based on terms that are negotiated by the two parties.

Unfortunately, the parties to the transaction (i.e., buyers and sellers) do not utilize a standard contract, nor do they buy and sell any form of bandwidth that may be considered fungible. That is, the characteristics of available bandwidth (e.g., capacity, duration, quality, and the like) may vary significantly, thus making a comparative analysis of the available bandwidth very difficult. Additionally, negotiations typically take several weeks or months, and once terms are agreed upon, it can take even longer for transaction approval, and, finally the provisioning of the bandwidth. During this period, price may change dramatically, yielding an undesirable transaction (from one party's perspective) with high transaction costs. Moreover, because of the unequal bargaining position between the bandwidth providers and the bandwidth consumers, bandwidth capacity is typically not transacted at a competitive market-based price.

What is needed, therefore, is a bandwidth commodity market that includes liquidity (i.e., maximum number of diverse industry players), credibility (i.e., linked to existing physical delivery mechanisms), and accountability (i.e., reliable level of service delivery).

The present invention is directed to overcoming, or at least reducing the effects of, one or more of the problems set forth above.

### SUMMARY OF THE INVENTION

In one aspect of the present invention, a method is provided. The method includes pooling bandwidth between first and second pooling points in a communication system. The pooled bandwidth is commoditized by making available tradeable bandwidth segments having negotiable sizes and characteristics. A transaction between a buyer and a seller for at least one bandwidth segment is initiated, wherein the seller delivers to the buyer bandwidth between the first and second pooling points pursuant to agreed upon terms. The delivered bandwidth is monitored to ensure that the bandwidth is delivered according to the agreed upon terms.

In another aspect of the present invention, a system is provided. The system includes a first pooling point, a second pooling point, a service provisioning system, a cross connection switch, and a quality of service manager. The second pooling point is coupled to the first pooling point and bandwidth is pooled between the first and second pooling points. The pooled bandwidth is commoditized by making available tradeable bandwidth segments having a negotiable size and a determinable quality of service. The service provisioning system is coupled to at least on of the first and second pooling points, and the service provisioning system facilitates a transaction between a buyer and a seller for bandwidth at a contracted for quality of service. The cross connection switch is coupled to at least one of the first and second pooling points, and the cross connection switch executes the transaction between the buyer and seller by enabling delivery of bandwidth between the first and second pooling points at the contracted for quality of service. The quality of service manager is coupled to at least one of the first and second pooling points, and the quality of service manager monitors the delivered bandwidth to ensure that the contracted for quality of service is delivered.

### BRIEF DESCRIPTION OF THE DRAWINGS

The invention may be best understood by reference to the following description taken in conjunction with the accompanying drawings, in which like reference numerals identify like elements, and in which:

FIG. 1 is an illustrative bandwidth trading system;

FIG. 2 illustrates delivery of a sample bandwidth contract executed by the bandwidth trading system shown in FIG. 1;

FIG. 3 is yet another illustrative bandwidth trading system;

FIG. 4 is an illustrative example of the pooling points shown in FIGS. 1 and 3;

FIG. 5 is a simplified block diagram illustrating one exemplary process for the bandwidth trading systems illustrated in FIGS. 1 and 3 in accordance with one aspect of the present invention;

FIG. 6 is an illustrative example of physical intermediation of bandwidth capacity;

FIG. 7 is an illustrative example of financial intermedation of bandwidth capacity.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

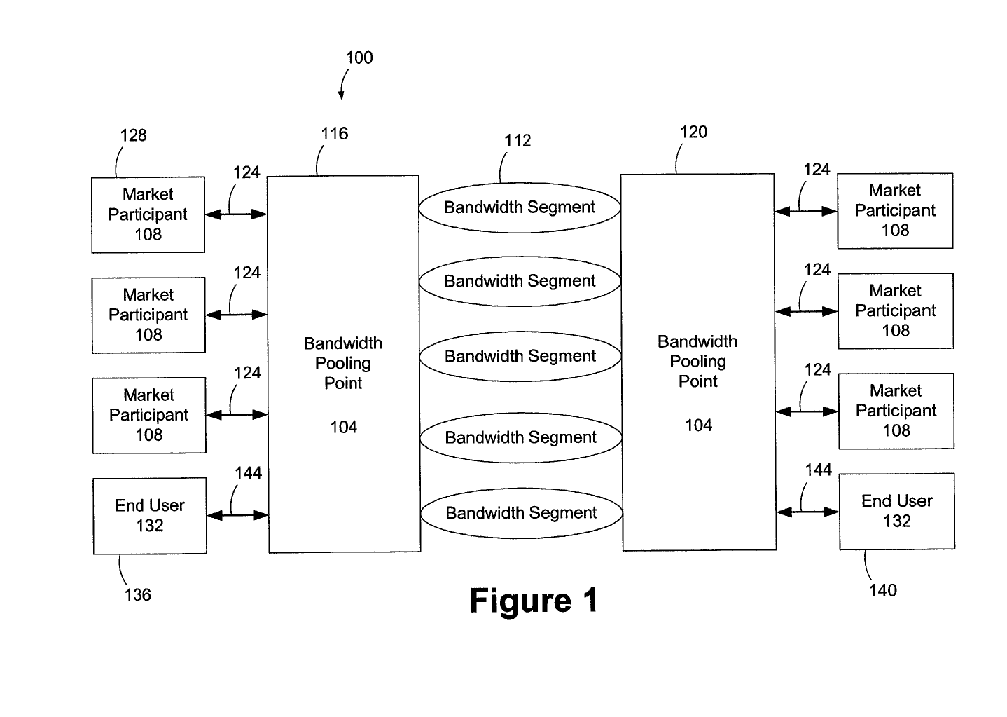

Referring to FIG. 1, an illustrative example of a bandwidth trading system 100 is shown. The bandwidth trading system 100 may be comprised of bandwidth pooling points 104, a plurality of market participants 108, and a plurality of bandwidth segments 112 interconnecting the pooling points 104. Generally, the pooling points 104 are implemented in pairs at the ends of city-pair segments that represent the most liquid telecommunication paths. In one illustrative embodiment, a first pooling point 116 is located in Los Angeles, and a second pooling point 120 is located in New York City. This city-pair segment (i.e., the telecommunication path between NYC and LA) may be used to serve a significant portion of North America data traffic.

The bandwidth trading system 100 may be used to facilitate the creation of a bandwidth commodity market, wherein fungible units of bandwidth may be traded between buyers and sellers. The market participants 108 may be the buyers and sellers of the fungible bandwidth in a bandwidth commodity market created by the bandwidth trading system 100. The market participants 108 may include ISPs, data backbone providers, aggregators of long distance minutes, large enterprise customers, and the like. Essentially, the market participants 108 (e.g., buyers and sellers) may be any entity interested in the buying or selling bandwidth (i.e., any user of bandwidth or any entity that is interested in the commodity trading of bandwidth).

The market participants 108 may be connected to the pooling points 104 using a signaling network 124. The signaling network 124 may be comprised of any number of known communication links. For example, the signaling network 124 may include local loops, circuit-switched connections, private intranets, leased lines, public Internet resources, wireless communication links, and the like.

In one illustrative embodiment, a first market participant 128 may be interested in becoming a bandwidth provider (i.e., seller) in the bandwidth trading system 100. To this end, the first market participant 128 may connect to the pooling points 104 using the signaling network 124. The bandwidth supplied by the first market participant 128 may be pooled, between the first and second pooling points 116, 120, with the bandwidth provided by other market participants 108. As will be described below, the first and second pooling points 116, 120 may be used to commoditize the pooled bandwidth into tradeable bandwidth segments 112 interconnecting the first and second pooling points 116, 120.

Bandwidth providers (sellers) may facilitate the routing of data, for bandwidth consumers (buyers), using a variety of techniques. In one illustrative embodiment, a bandwidth provider, such as the first market participant 128, may provide IP addresses of its network to the first and second pooling points 116, 120. To the first market participant 128 trading N units of bandwidth, the pooling points 104 may appear as network edge routers, which send N units of bandwidth traffic to the network of the first market participant 128. Once the bandwidth is traded, the pooling points 104 will use the bandwidth provider's IP addresses to forward the bandwidth consumer's traffic streams to the sellers IP address.

In another illustrative embodiment, data may be transmitted over a bandwidth provider's network, between the first and second pooling points 116, 120, using time division multiplexing (TDM). TDM function in the data link layer (layer 2) of the Open System Interconnection reference model. Those skilled in the art will appreciate that the data link layer is responsible for the transmission (i.e., framing) of data over a physical link. Moreover, TDM permits a variety of network layer protocols to be superimposed on top of it, including IP (Internet Protocol). Additionally, TDM is commonly used by major telecommunications firms around the globe.

To ensure efficient operation of the pooling points 104, the pooling points 104 may be configured such that the bandwidth trading system 100 does not route data traffic for the general Internet. For example, the first and second pooling points 116, 120 may be configured to only accept data originating from a bandwidth consumers (i.e., a market participant 108 that is the ultimate purchaser of a partcular bandwidth segments 112).

In one embodiment, the pooling points 104 may be configured to only accept data from certain IP addresses (e.g., the IP addresses of the bandwidth consumers). For a market participant 108 that is a purchaser of N units of bandwidth, the pooling points 104 appear as digital pathways, which offer N units of bandwidth capacity between the pooling points 104. Moreover, as described above, the pooling points 104 deliver all the in-contract traffic from the bandwidth purchaser to a selected bandwidth provider's network (i.e., seller's network). However, for market participants 108 that are not bandwidth providers (sellers) or bandwidth consumers (buyers), the pooling points 104 may appear as stub networks, refusing to route traffic for these market participants 108.

In yet another illustrative embodiment, any number of end users 132 (buyers) may be coupled to the pooling points 104. For example, the end users 132 (buyers) may be large consumers or traders of bandwidth having geographically dispersed locations near the first and second pooling points 116, 120. In one embodiment, the end users 132 (buyers) may purchase bandwidth segments 112 provided through the bandwidth trading system 100 to interconnect first and second end user locations 136, 140. The first and second end user locations 136, 140 may be, for example, regional offices of IBM, Compaq, Nations Bank, or any other large buyer of bandwidth. In other words, the end users 132 (buyers) may rely on the bandwidth trading system 100 to provide competitively priced connections (i.e., bandwidth segments 112) between the first and second end user locations 136, 140. Although only one end user pair 132 is shown in FIG. 1, it should be appreciated that any number of end users 132 (buyers) may be coupled to the pooling points 104, and the bandwidth trading system 100 may facilitate the interconnection of these end users 132 (buyers).

The first and second end user locations 136, 140 may be connected to the pooling points 104 using a signaling network 144. The signaling network 144 may be comprised of any number of available communication links. For example, the signaling network 144 may include local loops, circuit-switched connections, private intranets, leased lines, public Internet resources, wireless communication links, and the like. Moreover, the signaling network 144 may be provisioned by the end users 132 (buyers), a third party, or any combination of the two.

Using the bandwidth trading system 100, the end users 132 (buyers) may purchase competitively priced bandwidth segments 112 that closely match their bandwidth needs. For example, the end users 132 may purchase bandwidth segments 112 that offer a particular quality of service, duration, capacity, or any other desired characteristic. Moreover, the characteristics of the bandwidth segments 112 purchased by the end users 132 (buyers) may vary depending upon the needs of the end users 132. That is, the characteristics (e.g., duration, capacity, quality, terms, etc.) of the bandwidth pooled between the first and second pooling points 116,120 may vary, and buyers of the pooled bandwidth may select a particular bandwidth segment 112 according to their individual needs.

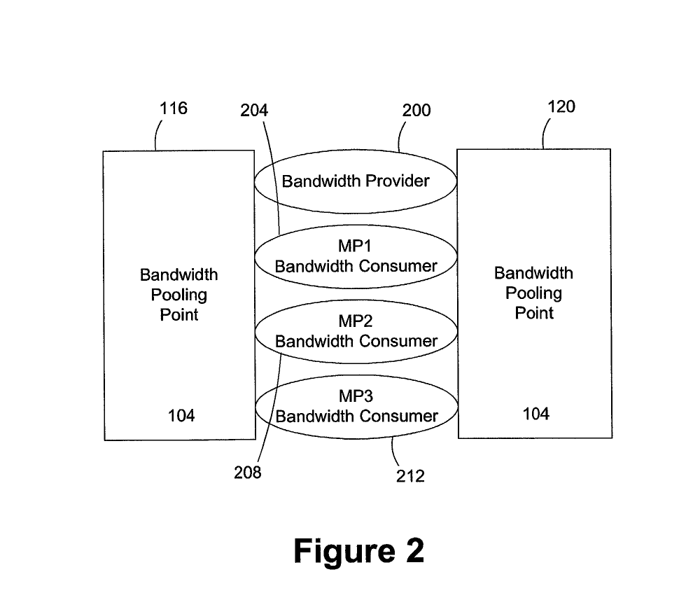

Referring to FIG. 2, an illustrative delivery of a bandwidth contract is shown. In this example, a bandwidth provider 200 (seller) of ten IP DS-3 segments of bandwidth is assigned, by the first and second pooling points 116, 120, to deliver bandwidth to three purchasing market participants 204, 208, 212 (also illustrated as MP1, MP2, and MP3 in FIG. 2).

MP1 may be a buyer of two DS-3 segments of bandwidth, MP2 may be a buyer of three DS-3 segments of bandwidth, and MP3 may be a buyer of five DS-3 segments of bandwidth. The first and second pooling points 116,120 are responsible for delivering up to 91.472 Mbps of traffic (two DS-3s) from MP1 to the seller's port based on the seller's IP address, up to 137.208 Mbps of traffic (three DS-3s) from MP2 to the seller's port using the same IP address, and up to 228.68 Mbps of traffic (five DS-3s) from MP3 to the seller's port, again using the same seller's IP address.

Referring to FIG. 1, although only two pooling points 104 are shown, it should be appreciated that the bandwidth trading system 100 may be comprised of any number of pooling points 104. Moreover, the pooling points 104 may operate under centralized control, decentralized control, or a combination of the two.

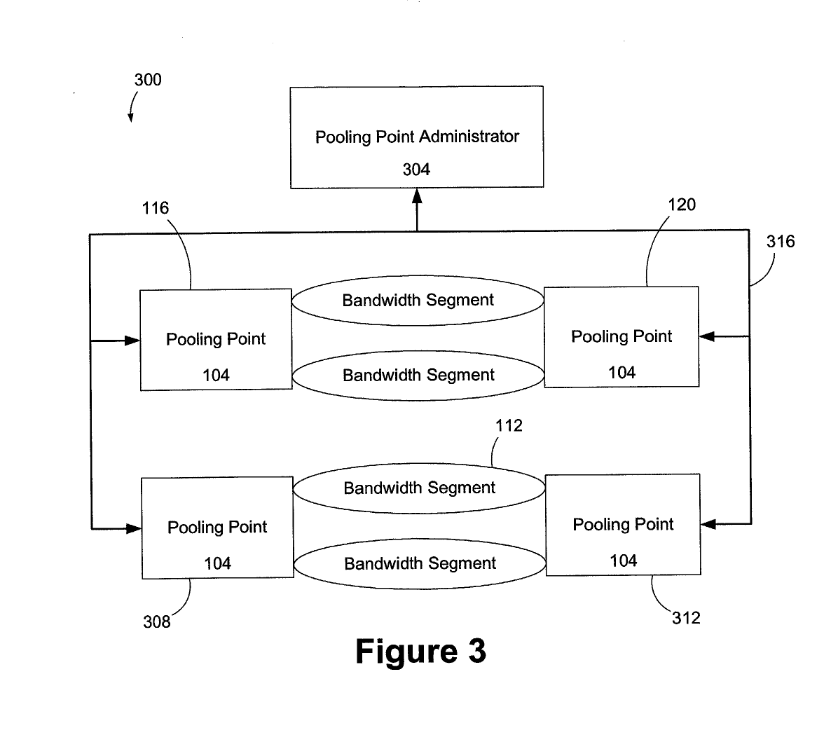

In FIG. 3, a bandwidth trading system 300 is shown having four pooling points 104 and a pooling point administrator 304. In one illustrative example, a third pooling point 308 may be located in NYC, while a fourth pooling point 312 is located in Europe. However, the specific city-pair segment served by a pooling point combination may vary depending upon a variety of factors, and the actual selection is typically a matter of design choice.

In this example, the pooling point administrator 304 may be used to provide centralized control of the pooling points 104. For example, the pooling point administrator 304 may be responsible for scheduling requested connections, ensuring the physical security and operational integrity of the pooling points 104, monitoring the quality of service of delivered bandwidth to ensure it meets the contracted for terms, provisioning, and the like. The pooling point administrator 304 may communicate with the pooling points 104 using a signaling network 316. The signaling network 316 may be implemented using a variety of known hardware devices and software protocols. However, in one example, the signaling network 316 uses InterAgent® communication messaging software described in U.S. Pat. No. 5,634,010, which is hereby incorporated by reference.

In one embodiment, the pooling point administrator 304 may be an independent third party. In this example, due to the independent nature of the pooling point administrator 304, the pooling points 104 may be owned by different entities, but perform similar services through the independent and centralized control of the pooling point administrator 304. To this end, the pooling administrator 304 may promulgate a combination of technology standards and installation requirements for both hardware and software, which a pooling point developer would follow in establishing a new pooling point 104 in the bandwidth trading system 300.

In creating additional pooling points 104, a pooling point developer would install and operate equipment necessary for the interconnection of bandwidth buyers (i.e., market participants 108) at each pooling point 104. The pooling point developer would be responsible for the physical maintenance and operation of the pooling point equipment and the relevant pooling point 104, the installation of the requisite software, availability of access for interconnection for market participants 108, the physical security of the pooling point equipment, installation for the pooling point administrator's remote monitor facility, provisioning and the like. It is therefore likely that some pooling point developers will subcontract some of the responsibility to qualified service and maintenance operators, such as Lucent, HP, Xerox, and the like.

In one illustrative embodiment, the various entities (e.g., pooling point developers, pooling point administrator 304, market participants 108, etc) in the bandwidth trading systems 100, 300 may belong to an industry organization, such as a bandwidth trading organization (BTO). The BTO may establish initial market rules and a governance system that may be responsible for a consensus-based administration of the commodity bandwidth market created by the bandwidth trading systems 100, 300. In this example, the BTO would not engage in trading but would administer rules designed to foster fair and competitive trading of bandwidth.

One important function of the BTO would be to identify, select, endorse, and publish technology standards and operational performance requirements for interconnection of all market participants 108 to the pooling points 104. In one embodiment, the market participants 108 may be required to pay for port access which allow their physical interconnection to any other market participant 108 with whom they might trade. The pooling point administrator 304 may be granted a service contract with the BTO to cover both initial pooling points 104 and, potentially, additional pooling points 104. The pooling point administrator 304 may be compensated by the BTO on a service fee basis. For example, members of the BTO may pay transaction charges to cover the services of the pooling point administrator 304 and other operational needs of the BTO.

As will be described below, bandwidth traders may have a right to recover liquidated damages from their respective counterparties in the event that the making or taking delivery of bandwidth does not meet prescribed quality of service standards agreed to by the counterparties or any other contractual term.

Generally, liquidated damages may be used to ensure the integrity of the bandwidth trading system 100. For example, the pooling point administrator 304 may provide verification to trading parties (e.g., market participants 108) on each trading contract of deficiencies in bandwidth deliveries. If a deficiency exists, the seller may be liable to the buyer for liquidated damages.

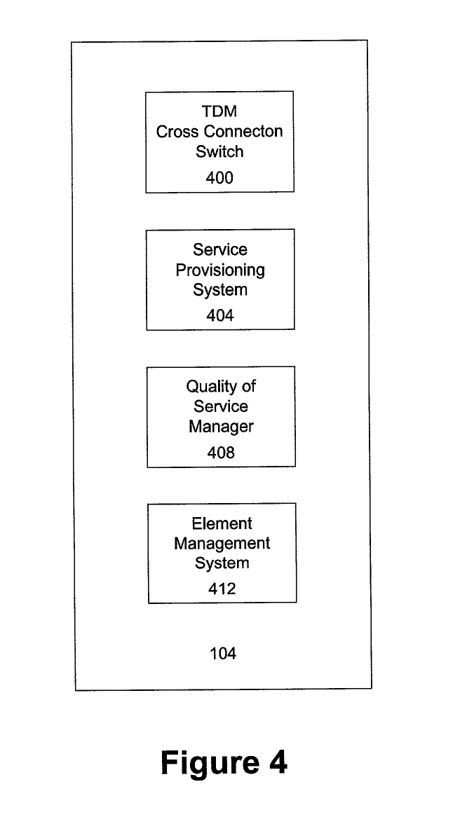

Referring to FIG. 4, an illustrative embodiment of the pooling points 104 is shown. The pooling point 104 is comprised of a TDM cross connection switch 400, a service provisioning system 404, a quality of service manager 408, and an element management system 412.

The TDM cross connection switch 400 may be used for connecting buyers with sellers to facilitate a bandwidth trade. The cross connection switch 400 may be comprised of a variety of known devices, and the particular selection may be a matter of design choice. However, in one embodiment, the cross connection switch 400 is a Lucent Technologies WaveStar™ Bandwidth Manager (BWM). The BWM comprises an integrated broadband cross-connect fabric that integrates the capabilities of traditional Digital Cross Connect Systems (DCSs) and Add/Drop Multiplexers (ADMs) into a single platform, which provides flexible bandwidth management and provisioning at the STM (Sonet/SDH) layer. The BWM is a scalable solution that is capable of being scaled between 1152 to 4608 to 9216 STS-1 capacity (i.e., 60 Gb/s, 240 Gb/s, and 480 Gb/s).

The service provisioning system 404 may be used for establishing, tracking and connecting market participants 108 (i.e., buyers and sellers of bandwidth) to the bandwidth trading system 100, 300. Again, the service provisioning system 404 may be comprised of a variety of known devices. In one illustrative embodiment, the service provisioning system 404 may be embedded in the BWM, and the service provisioning system 404 may be modified based on the demands of the market participants. For example, the service provisioning system may be capable of displaying a logical view of the BWM cross-connection configuration using SNMP. The display may be dynamically updated with information about cross-connections and the ports/time slots that are currently used in cross-connections. Moreover, the service provisioning system 404 may be capable of communicating with the pooling point administrator 304, illustrated in FIG. 3. By communicating with the service provisioning system 404, the pooling point administrator 304 may update the provisioning of existing equipment.

The quality of service manager 408 may be used for establishing, monitoring, and reporting performance. Again the quality of service manager 408 may be comprised of a variety of known devices. However, continuing with the example above, the quality of service manager 408 may be a Lucent Technologies WaveStar™ SubNetwork Management System (SNMS), which is deployed in concert with the BWM. Moreover, the WaveStar™ product family uses a layered bandwidth management approach capable of managing IP and ATM layers and the SONET/STM time-division and DWDM optical layers.

Finally, the element management system 412 may be used to monitor the health of the pooling point 104. Again, the element managing system 412 may be comprised of a variety of known devices, but in one illustrative embodiment, the element management system 412 is embedded in the BWM.

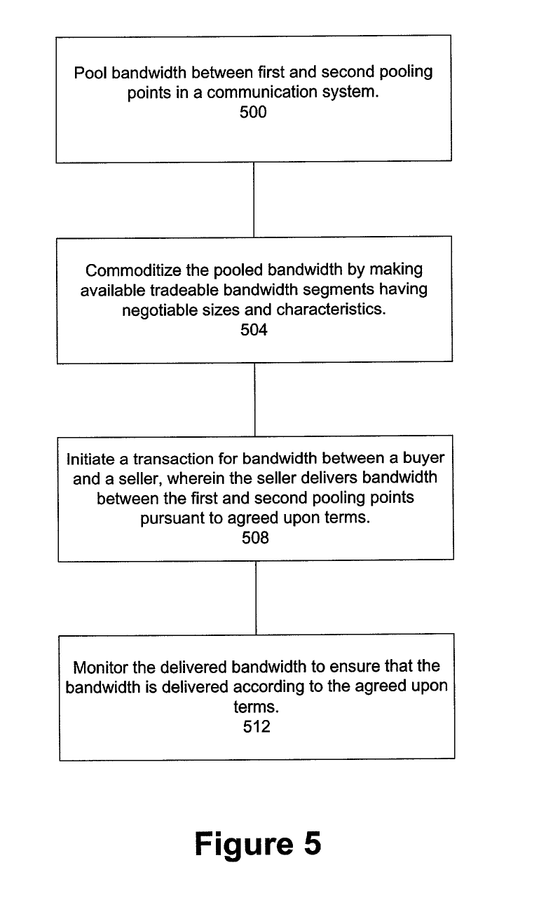

Referring to FIG. 5, a method for implementing a bandwidth trade between a buyer and a seller is shown. This process is discussed with reference to the bandwidth trading systems 100, 300 shown in FIGS. 1 and 3 to simplify illustrating the present invention. It should be appreciated that the configurations of the bandwidth trading systems 100, 300, shown in FIGS. 1 and 3, are just two of many possible solutions that may be used to implement the method of FIG. 5. As a result, the particular details of the bandwidth trading systems 100, 300, such as hardware, topography, connections, protocols, and the like should be considered for the purpose of illustration and not for the purpose of limitation. As described above, the exact details of the bandwidth trading systems 100, 300 may vary as a matter of design choice.

At block 500, of FIG. 5, bandwidth may be pooled between first and second pooling points 116, 120 in a communication system. As described in FIG. 1, a plurality of market participants 108 may be aggregated at two pooling points 104. Market participants 108 interested in selling bandwidth between the two pooling points 104 may have their bandwidth pooled with other interested sellers, and this bandwidth may be used to facilitate the transmission of consumer data (and therefore sales of bandwidth) between the two pooling points 104. Moreover, as will be described below, the pooled bandwidth may be commoditized and made available, for trade, in a bandwidth commodity market.

At block 504, the pooled bandwidth, in block 500, is commoditized by making available tradeable bandwidth segments 112 having negotiable sizes and characteristics. Generally, a bandwidth segment 112 may be defined as any finite capacity of bandwidth provided between two points for a designated period of time. The bandwidth segments 112 may be sold in any number of capacities offering different degrees of quality of service. Moreover, the market participants 108 and end users 132 may negotiate for desired terms when buying and selling the pooled bandwidth.

Those skilled in the art will appreciate that many bandwidth capacity standards exist in industry. For example, a DS1 line (T1) may be defined as having 1.544 Mb/s of bandwidth, a DSO line may be defined as having 64 kb/s of bandwidth, a DS2 line may be defined as having bandwidth equal to four DS1 lines, an OC-1 line may be defined as having 51.84 Mb/s of bandwidth, and so on.

In order to facilitate a bandwidth commodity market, it may be important that the market participants 108 trade in a similar unit of bandwidth granularity (i.e., measurable bandwidth quantity). In one embodiment, the bandwidth granularity of the bandwidth segments 112 is the capacity of one DS-0 bandwidth unit (64 kb/s). Multiple DS-0 bandwidth units may be aggregated to create a DS-3 unit of bandwidth. To simplify trades, market participants may decide to negotiate in larger bandwidth units, for example, DS-3 capacity or any other measurable unit.

In addition to bandwidth granularity, the pooled bandwidth, at block 500, may be further commoditized into tradeable bandwidth segments 112 having a determinable quality of service. For example, the pooled bandwidth may be further commoditized using standard quality of service guidelines. Those skilled in the art will appreciate that existing quality of service standards include error seconds, severely errored seconds, unavailable seconds, availability, latency, jitter, packet loss ratio, reliability, restoration time, service interruption, and the like. Generally, bandwidth segments 112 offering a relatively high level of quality of service may be expected to trade for a premium over bandwidth segments 112 offering a relatively low level of quality of service (i.e., there is usually a direct relationship between price and quality of service). However, as will be described below, sellers of bandwidth may be obligated to pay liquidated damages to a corresponding buyer if the agreed upon quality of service is not delivered.

Generally, errored seconds may be defined in a variety of ways. That is, the specific error thresholds may be arbitrarily determined based on a particular application. However, in one illustrative embodiment, an errored second may be defined as any second in which a minimum of one and a maximum of 44 bit errors have occurred. Similarly, severely errored seconds may be defined as any second in which there have been 45 or more bit errors. Finally, unavailable seconds may be a consecutive string of 10 or more severely errored seconds. For example, 9 consecutive severely errored seconds are not unavailable seconds, but 11 consecutive severely errored seconds are also 11 unavailable seconds.

Availability may be defined, as to a bandwidth segment 112, as the percentage of time over the applicable term (i.e., length of a bandwidth contract) for which a seller will make available the transmission of buyer traffic. Or, by way of formula: 1—(minutes of scheduled service outage/total minutes in the term), expressed as a percentage. Generally, the higher the percentage the better the quality of service.

Latency may be defined as the time interval between the transmission of the last bit of a packet, from one reference point, and the receipt of that same bit at a second reference point. Generally lower values for latency are associated with higher quality of service.

Jitter may be defined as the average over time in variation of latency for all packets of a constant size between two reference points (similar to standard deviation from a mean). Generally, lower values of jitter are associated with higher quality of service.

Packet loss ratio may be defined as the ratio of (i) the number of packets lost in transmission between two system interface points to (ii) the number of total packets transmitted between the two system interface points. Again, lower values of packet loss are associated with higher quality of service.

Reliability may be defined, as to the bandwidth segments 112, as the percentage of availability of bandwidth (see definition above) over the term of the transaction. Or, by way of formula: 1—(minutes of actual service outage/total minutes in the term), expressed as a percentage. Generally, higher values are associated with higher quality of service.

Restoration time may be defined as the amount of time from the occurrence of a service interruption until service has been restored in a manner that satisfies the required quality of service for a bandwidth segment 112. Generally, low restoration times are associated with higher quality of service.

Service interruption may be defined as any interruption, whether planned or unplanned, of transmission capability along a bandwidth segment 112 or at its endpoints (e.g., the first and second pooling points 116, 120). However service interruption may be defined not to include service interruption caused by the buyer, the pooling point, or a force majeure event.

As described above, the pooled bandwidth may be commoditized into bandwidth segments 112 having a determinable quality of service. It should be appreciated that the quality of service standards characterizing a bandwidth segment 112 may vary depending upon, for example, the bandwidth trading system 100, 300, the contract between the buyer and the seller, system constraints, and the like. However, to facilitate the existence of a bandwidth commodity market it may be useful to benchmark quality of service guidelines for the bandwidth segments 112. In one illustrative example, the following quality of service benchmark guidelines may be used:

No more than 400 errored seconds/day

No more than 4 severely errored seconds/day

No more than 26 unavailable seconds/month

Latency not more than 0.035 seconds one way

Jitter not greater than 0.001 seconds

Restoration time not greater than 0.250 seconds

Packet loss ratio less than 0.0001

Reliability of 99.9%

Availability of 99.99999%

Full Duplex

In this example, bandwidth segments 112 exhibiting a quality of service that exceeds the benchmark quality of service guidelines may generally be expected to trade at a premium, while bandwidth segments 112 exhibiting a quality of service that is below the benchmark guidelines would be expected to trade at a discount. Moreover, the buyers and sellers may contract for specific quality of service standards, and the bandwidth delivered by the seller may be monitored to ensure that the contracted for quality of service is delivered. Alternatively, a seller may agree to deliver bandwidth with a quality of service substantially similar to the benchmark quality of service guidelines. However, regardless of what quality of service is agreed upon between the buyer and the seller, if the contracted for quality of service is not delivered, the buyer may be entitled to liquidated damages.

In addition to bandwidth granularity and quality of service, the pooled bandwidth may be further commoditized into bandwidth segments 112 based on time duration granularity. That is, the bandwidth segment may be deliverable in variable time increments with staggered commencement dates. In one embodiment, the bandwidth segments 112 have a time duration granularity of one-month. For example, a bandwidth segment 112 may be traded, and the contract may be for 6 one-month increments commencing one month from the contract date. In another example, a bandwidth segment 112 may be traded, and the contract may be for 2 one-month increments commencing 36 months from the contract date. In yet another example, the bandwidth segments 112 may be sold in increments of 15 minutes (i.e., the time duration granularity would be 15 minutes). Of course, the time duration granularity and the commencement date may vary depending upon the agreed upon contractual terms between the buyer and the seller.

At block 508, a transaction for bandwidth between a buyer and a seller may be initiated, wherein the seller delivers bandwidth between the first and second pooling points 116, 120 at a contracted for quality of service. As described above, the bandwidth trading system 100, 300 may be used to create a bandwidth commodity market where buyers and sellers may conveniently and expeditiously initiate trades for bandwidth capacity between pooling points 104. Moreover, the specific terms of the transactions (e.g., capacity, quality, duration, commencement date, liquidated damages, etc.) may be negotiated by the buyers and sellers.

In one illustrative example, buyer 1 may be interested in acquiring bandwidth capacity between the first and second pooling points 116, 120. Buyer 1 may contact a plurality of sellers who are offering bandwidth capacity through the bandwidth trading system 100. Buyer 1 may decide to contract with seller 1, who may be offering the best price for the bandwidth capacity that buyer 1 is interested in. Buyer 1 and seller 1 may confirm the terms of their trade (e.g., price, term, quantity, quality of service, etc.) and then seller 1 may send buyer 1 a confirmation statement.

Prior to commencement of the term, buyer 1 and seller 1 may contact the pooling points 104 or the pooling point administrator 304 (depending upon the implementation of the bandwidth trading system 100) to arrange interconnection at the pooling points 104, confirm that the two sides of the deal match, and/or that circuit IDs have been provisioned at the pooling points 104. The circuit IDs may be used to connect buyer 1 with seller 1 and to facilitate both parties, the pooling point administrator 304, and/or any other party to monitor the performance of the contract.

To expedite the above transaction in an economical manner, a master agreement (i.e., standard agreement) may be used. The master agreement may provide for a balanced and fair agreement since market participants 108 may both buy and sell bandwidth capacity using the agreement. However, specific commercial terms such as price, duration, segment (i.e., NY to LA, NY to Europe, etc.), quantity, and quality of service, will likely have to be negotiated on a trade by trade basis. Nevertheless, using an accepted master agreement will promote fast and efficient trading of bandwidth capacity.

Back to the illustration above, if market conditions change (e.g., the price of bandwidth capacity goes up or down) buyer 1 may decide to resell the bandwidth capacity purchased from seller 1. For example, if the price of bandwidth capacity rises, buyer 1 may decide to sell and realize the increase in value of the bandwidth. To this end, buyer 1 may contact several buyers who wish to purchase bandwidth capacity between the first and second pooling points 116, 120. If buyer 1 initiates a trade with buyer 2, similar to the example above, buyer 1 and buyer 2 negotiate their commercial terms (e.g., price, term, quantity, and quality), and then, buyer 1 sends a confirmation statement to buyer 2. Alternatively, the deal may be completed orally, online, or through any other accepted means.

Buyer 1 and buyer 2 may arrange interconnection at the pooling points 104 and/or contact the pooling point administrator 304 to confirm the two sides of the deal match and that the circuit IDs have been provisioned at the pooling points 104. In this case, the pooling points 104 may automatically use the same circuit ID that buyer 1 used to both buy and sell, thus, “netting” the transaction. Buyer 2 may then send payment to buyer 1, and buyer 1 would both receive payment for the trade and pay seller 1 at the same time. It should be appreciated that many similar trades may take place and that the intermediate transactions, although originally intended by the parties to be physically delivered, would be settled in cash (i.e., a commodity market for bandwidth is created).

Referring back to FIG. 5, at block 512, the delivered bandwidth may be monitored to ensure that the bandwidth is delivered according to the agreed upon terms. In one illustrative embodiment, the quality of service manager 408, illustrated in FIG. 4, may be used to collect and store performance monitoring data related to the quality of service being exhibited by the traded for bandwidth segments 112. Following this example, if the cross connection switch is a BWM from Lucent Technologies, the quality of service manager 408 (e.g., SNMS) may specify the port types for which data is to be collected and may periodically collect the performance monitoring data. For example, the quality of service manager 408 may collect performance monitoring data on a fifteen minute schedule, and this data may be stored in a performance monitoring database by the pooling points 104.

The performance monitoring database may be used to generate reports which may be compared against the quality of service standards agreed to in connection with the underlying bandwidth trades. Of course, these reports may be produced and the comparison made electronically, or the processes may be done manually.

In FIG. 3, the pooling point administrator 304 may be used to monitor the delivered bandwidth in concert with the quality of service manager 408. That is, the process described above may still be used, but the pooling point administrator 304 may schedule, monitor, and compare the delivered quality of service against the quality of service contracted for by the buyer and seller. For example, the quality of service manager 408 may be used as an intermediary storage point to provide centralized access to performance monitoring data. The quality of service manager 408 may be used in conjunction with more sophisticated data report generation systems, such as Lucent Technology's ITM and DNA.

In another embodiment, the quality of service manager 408 may monitor the delivered bandwidth between the pooling points 104 using a performance exception system, wherein threshold crossing alerts are logged in the form of reported events. In this example, quality of service thresholds may be set by the quality of service manager 408, and when these thresholds are crossed for a particular connection, a threshold crossing alert may be generated. For example, latency may be set to a threshold value of 0.035 seconds. If this threshold value is exceeded, a threshold crossing alert may be generated and stored in the performance monitoring database of the pooling points 104. The threshold crossing alerts may be available for on-line queries by the quality of service manager 408.

As described above, the buyers and sellers of the bandwidth segments 112 may contract for a specific quality of service. The contracted for quality of service may be negotiated or may be based upon industry accepted benchmark quality of service guidelines. The pooling points 104 (e.g., the quality of service manager 408, TDM cross connection switch 400, etc.) may monitor bandwidth delivered between the pooling points 104 and determine whether the contracted for quality of service is delivered. If the contracted for quality of service is not delivered, the buyers of the bandwidth segments 112 may be entitled to liquidated damages. The amount of liquidated damages may be included as a standard term in the master agreement or may be specifically negotiated by the parties before the bandwidth is delivered.

Additionally, the agreed upon terms, between the buyer and seller, may include a take or pay provision requiring the buyer of the bandwidth to pay the seller for the delivered bandwidth regardless of whether the buyer uses the bandwidth. In other words, the agreed upon terms between the buyer and the seller may result in a firm contract that is strictly enforced though liquidated damages and the take or pay provision. Rather than having a buyer of bandwidth dominated by the seller, liquidated damages may create a more equal playing field for the parties, while a take or pay provision provides a degree of protection for the seller. Thus, regardless of what might occur after the contractual terms are negotiated, the parties may be held to strict conformance of the terms of the deal.

Once a commodity market for bandwidth has been established, the bandwidth trading systems 100, 300 may be used to generate revenue through physical intermediation. For example, a commodity market may facilitate the purchase of large segments of bandwidth at a volume discounts. These large segments of bandwidth may be divided into smaller blocks, and the blocks may be individually sold at a greater value than the whole (i.e., scale economies may create an arbitrage opportunity).

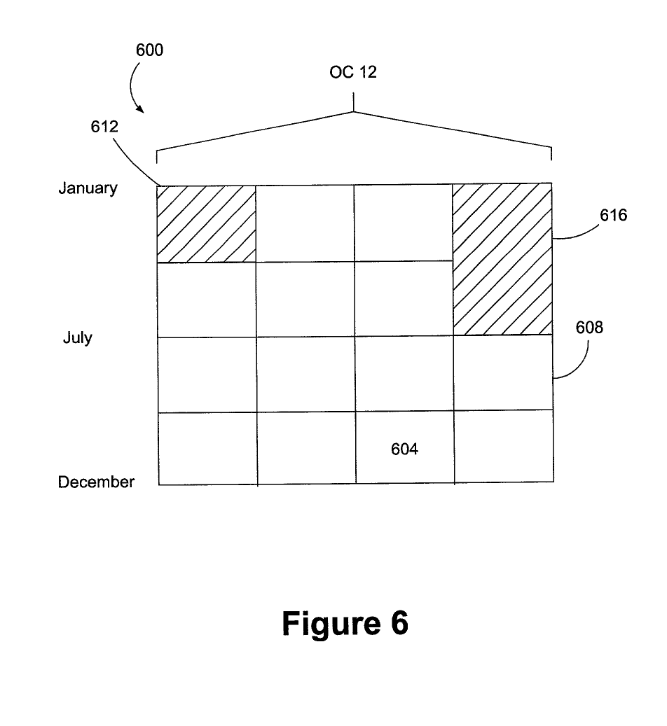

Referring to FIG. 6, a large segment of bandwidth 600 is shown. The segment of bandwidth 600 may be marketed as many small blocks 604 having varying terms and bandwidth capacities. For example, a first block of bandwidth 608 is shown having a commencement date of July and a termination date of September. Additionally, the first block of bandwidth 608 is illustrated having an OC-3 capacity. The smaller blocks 604 may be sold/leased to other market participants 108 at a higher value than was originally paid for the bandwidth segment 600. That is, the total value of the individual blocks 604 (16 in this example) may be greater than the value of the bandwidth segment 600 as a whole. Additionally, the bandwidth trading system 100, by aggregating many market participants 108 at the pooling points 104, may reduce the costs associated with reselling the blocks of bandwidth 604.

In the example of FIG. 6, a first section of bandwidth 612, comprising one bandwidth block 604, may be sold/leased to AT&T. The first section of bandwidth 612 may have a commencement date of January and a termination date of March. Moreover, the first section of bandwidth 612 may have an OC-3 capacity.

In another illustrative example, a second section of bandwidth 616 may be sold to MCI. The second section 616 may have a commencement date of January and a termination date of June. The second section of bandwidth 616 may also have an OC-3 capacity.

In addition to physical intermediation, a commodity market for bandwidth may be used to generate revenue through financial intermediation. For example, a seller may take over the existing contract of a buyer and offer the buyer another bandwidth contract that lowers the annual payments but extends the contract an additional number of years.

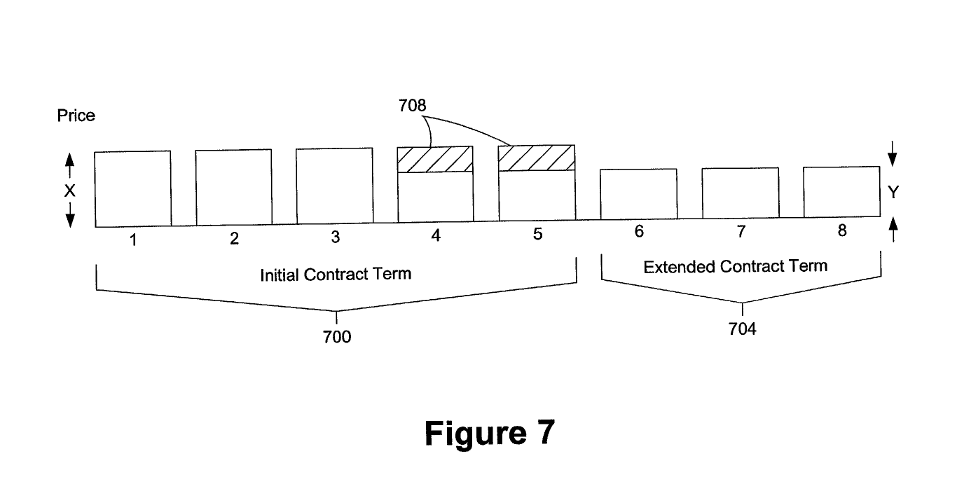

Referring to FIG. 7, a sample financial intermediation deal is shown. In this example, an initial contract term 700 is shown having a price X and a 5 year duration. In this example, a seller is shown to have taken over the initial contract term 700 in year 4 and added an extended contract term 704 through year 8. For years 4 through 8, the initial contract price X is reduced to a price Y, but the buyer is now obligated through year 8. The cost savings for the buyer, in the fourth and fifth years, is illustrated by a shaded portion 708, and the shaded portion 708 may be expressed quantitatively as X-Y.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
pooling bandwidth between first and second pooling points in a communication system;
commoditizing the pooled bandwidth by making available tradeable bandwidth segments having negotiable sizes and characteristics;
initiating a transaction between a buyer and a seller for at least one bandwidth segment, wherein the seller delivers to the buyer bandwidth between the first and second pooling points pursuant to agreed upon terms; and
monitoring the delivered bandwidth to ensure that the bandwidth is delivered according to the agreed upon terms.

2. The method of claim 1, wherein commoditizing the pooled bandwidth comprises making available tradeable bandwidth segments having a determinable quality of service.

3. The method of claim 2, wherein initiating a transaction between a buyer and a seller for at least one bandwidth segment, comprises delivering to the buyer bandwidth between the first and second pooling points at a contracted for quality of service.

4. The method of claim 3, wherein monitoring the delivered bandwidth between the first and second pooling points comprises monitoring the delivered bandwidth to ensure that the contracted for quality of service is delivered.

5. The method of claim 4, further comprising the seller paying liquidated damages to the buyer if the contracted for quality of service is not delivered.

6. The method of claim 1, wherein commoditizing the pooled bandwidth comprises making available tradeable bandwidth segments having capacity sizes that substantially correspond with accepted industry standards.

7. The method of claim 6, wherein the capacity sizes of the tradeable bandwidth segments have a bandwidth granularity of at least a DS-0.

8. The method of claim 6, wherein the capacity size of the tradeable bandwidth segments substantially corresponds with that of a DS-3.

9. The method of claim 1, further comprising the seller paying liquidated damages to the buyer if the bandwidth is not delivered according to the agreed upon terms.

10. The method of claim 1, wherein initiating a transaction between a buyer and a seller for bandwidth comprises initiating the transaction pursuant to a master agreement having standard terms related to purchases and sales of bandwidth.

11. The method of claim 10, further comprising the seller paying liquidated damages to the buyer if the bandwidth is not delivered according to the standard terms in the master agreement.

12. The method of claim 10, wherein the standard terms of the master agreement include a take or pay provision requiring the buyer of the bandwidth to pay the seller for the delivered bandwidth regardless of whether the buyer uses the bandwidth.

13. The method of claim 1, wherein pooling bandwidth between first and second pooling points comprises connecting a plurality of buyers and sellers of bandwidth to at least one of the first and second pooling points.

14. The method of claim 13, wherein initiating a transaction between a buyer and a seller for at least one bandwidth segment comprises interconnecting the buyer and the seller through at least one of the first and second pooling points.

15. The method of claim 1, wherein the agreed upon terms between the buyer and the seller include a take or pay provision requiring the buyer of the bandwidth to pay the seller for the delivered bandwidth regardless of whether the buyer uses the bandwidth.

16. The method of claim 1, wherein the agreed upon terms between the buyer and the seller result in a firm contract that is strictly enforced.

17. The method of claim 16, further comprising the seller paying liquidated damages to the buyer for nonperformance of the firm contract.

18. The method of claim 16, wherein the firm contract between the buyer and the seller includes a take or pay provision requiring the buyer of the bandwidth to pay the seller for the delivered bandwidth regardless of whether the buyer uses the bandwidth.

19. A method, comprising:
pooling bandwidth between first and second pooling points in a communication system;
commoditizing the pooled bandwidth by making available tradeable bandwidth segments having a negotiable size and a determinable quality of service;
initiating a transaction between a buyer and a seller for at least one bandwidth segment, wherein the seller delivers to the buyer bandwidth between the first and second pooling points at a contracted for quality of service; and
monitoring the delivered bandwidth to ensure that the contracted for quality of service is delivered.

20. The method of claim 19, further comprising the seller paying liquidated damages to the buyer if the contracted for quality of service is not delivered.

21. The method of claim 19, wherein commoditizing the pooled bandwidth comprises making available tradeable bandwidth segments having capacity sizes that substantially correspond with accepted industry standards.

22. The method of claim 21, wherein the capacity sizes of the tradeable bandwidth segments have a bandwidth granularity of at least a DS-0.

23. The method of claim 19, wherein commoditizing the pooled bandwidth by making available bandwidth segments having a determinable quality of service comprises:
categorizing the pooled bandwidth into bandwidth segments according to the quality of service exhibited by the pooled bandwidth; and
pricing the bandwidth segments according to their quality of service, wherein bandwidth segments exhibiting a relatively high quality of service trade at a premium over bandwidth segments exhibiting a relatively low quality of service.

24. The method of claim 19, wherein commoditizing the pooled bandwidth by making available bandwidth segments having a determinable quality of service comprises:
comparing the pooled bandwidth against benchmark quality of service guidelines; and
based on the comparison, categorizing the pooled bandwidth into bandwidth segments, wherein bandwidth segments exhibiting a relatively high quality of service are distinguishable from bandwidth segments exhibiting a relatively low quality of service.

25. The method of claim 24, wherein a transaction for bandwidth, between the buyer and the seller, offering a quality of service that exceeds the benchmark quality of service guidelines trades at a premium.

26. The method of claim 24, wherein a transaction for bandwidth, between the buyer and the seller, offering a quality of service that is below the benchmark quality of service guidelines trades at a discount

27. The method of claim 19, wherein initiating a transaction between a buyer and a seller for bandwidth comprises initiating the transaction pursuant to a master agreement having standard terms related to purchases and sales of bandwidth.

28. The method of claim 27, further comprising the seller paying liquidated damages to the buyer if the bandwidth is not delivered according to the standard terms in the master agreement.

29. The method of claim 27, wherein the standard terms of the master agreement include a take or pay provision requiring the buyer of the bandwidth to pay the seller for the delivered bandwidth regardless of whether the buyer uses the bandwidth.

30. The method of claim 19, wherein monitoring the delivered bandwidth between the first and second pooling points to ensure that the contracted for quality of service is delivered comprises:
collecting performance monitoring data related to the quality of service being exhibited by the delivered bandwidth; and
comparing the performance monitoring data against the contracted for quality of service of the bandwidth.

31. The method of claim 30, wherein the performance monitoring data is collected on a predetermined schedule.

32. The method of claim 19, wherein monitoring the delivered bandwidth between the first and second pooling points to ensure that the contracted for quality of service is delivered comprises:
setting quality of service thresholds that are related to the contracted for quality of service of the bandwidth;
monitoring the delivered bandwidth between the first and second pooling points; and
generating a threshold crossing alert if the quality of service threshold is crossed.

33. The method of claim 19, further comprising:
initiating a second transaction between the buyer and a second buyer for the bandwidth;
selling the bandwidth to the second buyer; and
delivering the bandwidth to the second buyer.

34. The method of claim 19, wherein pooling bandwidth between first and second pooling points comprises connecting a plurality of buyers and sellers of bandwidth to at least one of the first and second pooling points.

35. The method of claim 34, wherein initiating a transaction between a buyer and a seller for at least one bandwidth segment comprises interconnecting the buyer and the seller through at least one of the first and second pooling points.

36. A method, comprising:
pooling bandwidth between first and second pooling points in a communication system;
commoditizing the pooled bandwidth by making available tradeable bandwidth segments having a negotiable size and a determinable quality of service;
initiating a transaction between a buyer and a seller for at least one bandwidth segment, wherein the transaction is pursuant to a master agreement having standard terms related to purchases and sales of bandwidth, and the seller delivers to the buyer bandwidth between the first and second pooling points at a contracted for quality of service; and
monitoring the delivered bandwidth to ensure that the contracted for quality of service is delivered.

37. The method of claim 36, further comprising the seller paying liquidated damages to the buyer if the contracted for quality of service is not delivered.

38. The method of claim 36, wherein the standard terms of the master agreement include a take or pay provision requiring the buyer of the bandwidth to pay the seller for the delivered bandwidth regardless of whether the buyer uses the bandwidth.

39. The method of claim 36, wherein pooling bandwidth between first and second pooling points comprises connecting a plurality of buyers and sellers of bandwidth to at least one of the first and second pooling points.

40. The method of claim 39, wherein initiating a transaction between a buyer and a seller for at least one bandwidth segment comprises interconnecting the buyer and the seller through at least one of the first and second pooling points.

41. A bandwidth trading system, comprising:
a first pooling point;
a second pooling point coupled to the first pooling point, wherein bandwidth is pooled between the first and second pooling points, and the pooled bandwidth is commoditized by making available tradeable bandwidth segments having a negotiable size and a determinable quality of service;
a service provisioning system coupled to at least one of the first and second pooling points, wherein the service provisioning system facilitates a transaction between a buyer and a seller for bandwidth at a contracted for quality of service;
a cross connection switch coupled to at least one of the first and second pooling points, wherein the cross connection switch executes the transaction between the buyer and seller by enabling delivery of bandwidth between the first and second pooling points at the contracted for quality of service; and
a quality of service manager coupled to at least one of the first and second pooling points, wherein the quality of service manager monitors the delivered bandwidth to ensure that the contracted for quality of service is delivered.

42. The system of claim 41, further comprising a pooling point administrator coupled to the first and second pooling points over a signaling network.

43. The system of claim 42, wherein the pooling point administrator provides centralized control of the pooling points.

44. The system of claim 42, wherein the pooling point administrator determines when the contracted for quality of service has not been delivered.

45. The system of claim 44, wherein in response to nonperformance of the contracted for quality of service the pooling point administrator notifies the seller of its obligation to pay the buyer liquidated damages.

46. The system of claim 41, further comprising a performance monitoring database wherein the quality of service manager:
stores performance monitoring data in the performance monitoring database;
compares the performance monitoring data against the contracted for quality of service; and
determines whether the contracted for quality of service has been delivered.

47. The system of claim 46, wherein in response to nonperformance of the contracted for quality of service the quality of service manager notifies the seller of its obligation to pay the buyer liquidated damages.

48. The system of claim 41, further comprising a plurality of service providers coupled to at least one of the first and second pooling points.

49. The system of claim 48, wherein in response to the transaction for bandwidth between the buyer and the seller, the cross connection switch interconnects the buyer and the seller through at least one of the first and second pooling points.

50. A method, comprising:
pooling bandwidth between first and second pooling points in a communication system;
purchasing a segment of the pooled bandwidth;
marketing the segment of bandwidth as tradeable bandwidth blocks, wherein the bandwidth blocks are capable of interconnecting the first and second pooling points and have a bandwidth capacity and a time period duration that is less than the segment of bandwidth; and
selling the bandwidth blocks.

51. The method of claim 50, wherein purchasing a segment of pooled bandwidth comprises:
negotiating with a plurality of sellers;
selecting a segment of bandwidth from a seller offering an optimal price; and
purchasing the segment of bandwidth pursuant to a master agreement having standard terms related to purchases and sales of bandwidth.

52. The method of claim 51, wherein selecting a segment of bandwidth from a seller offering an optimal price comprises:
evaluating the credit worthiness of a potential seller; and
selecting a segment of bandwidth from a seller that is an acceptable credit risk and is offering bandwidth at a lowest price.

53. The method of claim 51, wherein selecting a segment of bandwidth from a seller offering an optimal price comprises:
evaluating the quality of service of available bandwidth segments; and
selecting a segment of bandwidth from a seller that is offering bandwidth segments that exhibit an acceptable quality of service, and the seller is offering the acceptable bandwidth at a lowest price.

54. The method of claim 51, further comprising the seller paying liquidated damages to the buyer if the bandwidth is not delivered according to the standard terms in the master agreement.

55. The method of claim 50, wherein selling the bandwidth blocks comprises selling the bandwidth blocks pursuant to a master agreement having standard terms related to purchases and sales of the bandwidth blocks.

56. The method of claim 55, further comprising the seller paying liquidated damages to the buyer if the bandwidth is not delivered according to the standard terms in the master agreement.

57. A method, comprising:
pooling bandwidth between first and second pooling points in a communication system;
taking over a first contract between a buyer and a seller, wherein the first contract is for bandwidth capacity between the first and second pooling points and is characterized by a first duration and a first price; p1 selling the buyer a second contract for bandwidth capacity between the first and second pooling points, the second contract extending the first duration of the first contract and having a second price that is less than the first price.

58. The method of claim 57, wherein selling the buyer a second contract for bandwidth capacity comprises initiating a transaction pursuant to a master agreement having standard terms related to purchases and sales of bandwidth.

59. The method of claim 58, further comprising the seller paying liquidated damages to the buyer if the bandwidth is not delivered according to the standard terms in the master agreement.

60. A system comprising:
means for pooling bandwidth between first and second pooling points in a communication system;
means for commoditizing the pooled bandwidth by making available tradeable bandwidth segments having a negotiable size and a determinable quality of service;
means for initiating a transaction between a buyer and a seller for at least one bandwidth segment, wherein the seller delivers to the buyer bandwidth between the first and second pooling points at a contracted for quality of service; and
means for monitoring the delivered bandwidth to ensure that the contracted for quality of service is delivered.

61. The system of claim 60, further comprising means for the seller paying liquidated damages to the buyer if the contracted for quality of service is not delivered.

62. The system of claim 60, further comprising:
means for initiating a second transaction between the buyer and a second buyer for the bandwidth;
means for selling the bandwidth to the second buyer; and
means for delivering the bandwidth to the second buyer.
